(19) United States
(12) Patent Application Publication
(10) Pub. No.: US 2010/0295297 A1
(43) Pub. Date: Nov. 25, 2010

(54) LIGHTWEIGHT HIGH STRENGTH FLANGED COUPLING UNIT

(76) Inventors: Jason Anthony Martin, Torrington, CT (US); Christopher M. Fernald, Enfield, CT (US); Russel Hugh Marvin, Goshen, CT (US)

Correspondence Address: TED PAULDING, 10 PENWOOD LA, WETHERSFIELD, CT, 06109, US

(21) Appl. No.: 12/454,526

(22) Filed: May 19, 2009

(51) Int. Cl. F16L 23/00

(52) U.S. Cl. 285/405

(57) ABSTRACT

A flanged coupling unit having a radial flange with an axial boss and a concave exterior corner surface approximating the external surface of a quadrant of an ellipse. Optionally, a similar internal surface is provided. In either case, the resulting unit exhibits substantially enhanced strength and structural integrity and a significant reduction in weight.

### BACKGROUND OF THE INVENTION

Flanged coupling units having radial annular flanges and integral axial bosses have been used for perhaps a century or more in the interconnection of elongated tubular conduits and elongated structural members and the like. However, despite the long life of these couplings, little or no improvement has been realized in their design and construction.

Conventional coupling units tend to have their weakest and fracture prone areas at the junction or corner between their radial flanges and integral axial bosses. In an attempt to overcome this problem, couplings with frusto-conical bosses have been designed using considerably more material and with a consequent substantial increase in weight. However, weak and fracture prone areas are still encountered at small fillets occurring at relatively thin cross sectional areas at the ends of the frusto-conical surface area.

It is the general object of the present invention to redesign flanged coupling units of the type under consideration and thus provide improved units both lighter in weight and of greater strength and structural integrity.

### SUMMARY OF THE INVENTION

In accordance with the present invention and in fulfillment of the foregoing object, a flanged coupling unit is provided for primary use individually or with a similar unit in interconnected mating relationship for the endwise connection of axially aligned elongated members. The unit has a radial annular flange with at least a partial generally planar surface on one side. Means are provided for rigidly connecting the flange individually with a foundation or other surface or with the mating flange of a similar coupling unit, the planar surfaces of the two flanges being interengaged in face-to-face relationship. A boss formed integrally with the flange forms an external corner surface area therewith on the side thereof opposite its planar surface and projects axially therefrom for connection with an end portion of a first elongated member, the mating flange of a second coupling having a similar boss for connecting a second elongated member in endwise relationship with the first member.

An important feature of the invention resides in the contour of the corner area and the external surfaces adjacent and on opposite sides thereof. The adjacent area extending along the neck of the boss to the corner area, the corner area, and the adjacent area on the opposite side thereof along the inner portion of the flange are arcuate-concave viewed in a radial direction and are bounded by two points, or, more accurately, two imaginary annular lines, the first being spaced substantially outwardly along the axial surface on the neck of the boss. A second imaginary annular line on the flange is spaced outwardly along the radial length of the flange. The boundary line on the boss is substantially farther from the corner area than the similar line on the flange and the external surface curves gradually adjacent the former and substantially more rapidly adjacent the latter. Stated differently, the surface adjacent the line on the boss has a shallow slope relative to the axis of the boss and the arcuate surface adjacent the line on the flange has a substantially sharper slope relative to the axis. Still another way to view the contour of the external surface is the definition of the same by reference to the radii of curvature involved. The arcuate-concave surface is defined by at least three discrete radii of curvature, the smallest radius appearing adjacent the flange. Preferably there are an infinite number of radii of curvature employed in establishing the desired contour of the surface. In any event the radii blend smoothly so as to present a continuously varying gradually curved surface closely similar to that of a quadrant of an ellipse.

In addition to the foregoing it should be noted that where the flange and boss have an axially extending through opening or bore, the internal corner and adjacent areas may be arcuate-convex in a manner similar to that of the external corner and adjacent areas. With regard to both external and internal corner and adjacent areas, it should also be noted that in preferred form an external quadrant surface of an ellipse is approximated by each of the surfaces.

Another feature of the invention resides in the provision of the coupling unit having a radial flange and axial boss with an axial bore as aforesaid, wherein the wall thickness of the boss increases from the free end of the boss inwardly along its neck and substantially throughout its length, through the junction or corner area between the boss and the flange and thereafter remains substantially constant in progression radially outwardly along the flange. This feature may occur alone but is inherent with and of particular importance in combination with the aforesaid feature relating to the curvature of inner and or outer external corner and oppositely adjacent areas.

### DESCRIPTION OF THE DRAWINGS

FIG. 1 of the drawings is a side elevational section of a PRIOR ART flanged coupling unit,

FIG. 2 is a side elevation in section of a second PRIOR ART flanged coupling unit,

FIG. 3 is a side elevation in section of an improved flanged coupling unit in accordance with the present invention,

FIG. 4 is a side elevation in section of a second embodiment of an improved flanged coupling unit in accordance with the present invention,

FIG. 5 is a side elevation of a third embodiment of an improved flanged coupling unit in accordance with the present invention,

FIG. 6 is a schematic view of a tower employing a number of improved flange coupling units interconnecting elongated tubular structural members,

FIG. 7 is an enlarged sectional view of an assembled coupling employing a pair of similar units with flanges bolted together to interconnect hollow tubular structural units as in FIG. 6,

FIG. 8 is a view similar to FIG. 7, but employing an alternative means in the form of a clamp connecting the flanged coupling units,

FIG. 9 is an enlarged elevational view in section showing an improved coupling unit used individually in mounting an elongated generally vertical support member for a wind tower or the like.

### DESCRIPTION OF PREFERRED EMBODIMENTS

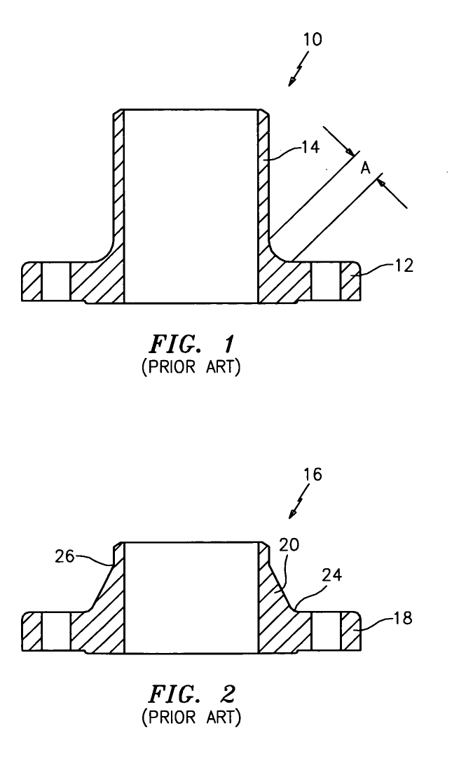

Referring particularly to FIG. 1, a PRIOR ART coupling unit is indicated generally at 10 and comprises a radial flange 12 and an axial boss 14 formed integrally with the flange. A junction or corner area between the boss and flange is indicated at A and is conventionally defined by a curve on a relatively small radius. In either event, the corner region A is the weakest area in the flanged unit and the area most likely to fracture under heavy load.

The PRIOR ART flanged unit of FIG. 2 indicated generally at 16 includes a radial flange 18 and a boss 20 which projects axially therefrom. The boss 20 is frusto-conical in configuration and obviously provides a much thicker wall and increased strength at the junction or corner area between the boss and the flange. It should be noted, however, that there is substantially more material used resulting in a substantially heavier and more expensive unit. Further, the unit remains subject to fracture at the small fillets 24, 26 at inner and outer ends of the frusto-conical section of the boss.

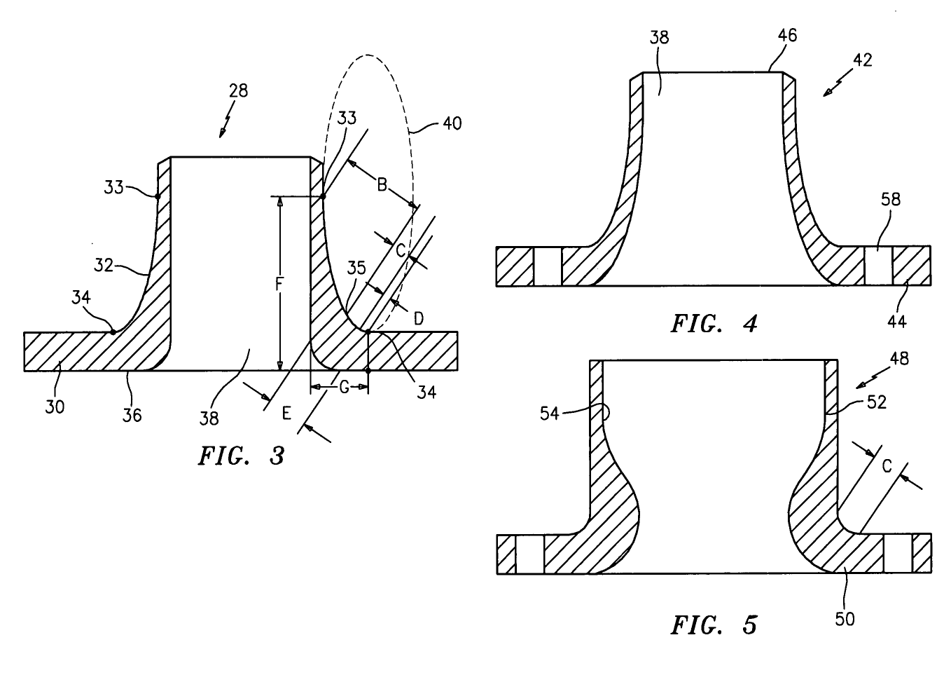

In FIG. 3, a first embodiment of the present invention is indicated generally at 28 and has a radial flange 30 and an axial boss 32 projecting axially therefrom. A corner area at the junction of the flange and boss is indicated generally at C with adjacent area B extending from the corner region along the neck and toward the free end of the boss. A second and substantially smaller area D adjacent the corner area C on its opposite side extends along the flange 30 toward its free end. A through opening or axial bore 35 extends from the free end of the boss to a planar surface 36 on the flange which resides in a radial plane. The corner or junction E between the planar surface 36 and internal annular surface 35 of the boss 32 is defined by a convex curve E also on a relatively small radius.

As mentioned above, the external surfaces of the unit at B, C, and D are bounded by two points or imaginary annular lines 33,34 respectively on the axial surface of the boss and the radial surface of the flange. The former line is substantially farther from the corner than the latter as indicated by the dimensions F, G. As will be apparent on inspection, the external surface 35 curves gradually adjacent the boundary line 33 and substantially more rapidly adjacent the boundary line 34 on the flange. At each end, however, the arcuate surface blends smoothly in transition to a linear surface on the opposite side of the boundary line. As stated above the curve may also be regarded as having a gently changing slope adjacent the boss and a more sharply changing slope adjacent the flange. Still further, the external surface 35 may be viewed as defined by at least three, and preferably an infinite number of discrete radii. In any event, the portions of the surface blend together to form a continuously varying smooth arcuate surface with the surface of the smallest radius on the flange 30. Preferably the surfaces B, C, D, taken in the aggregate, at least approximately follow the contour of the external surface of a quadrant of an ellipse, shown in broken line at 40.

As mentioned above, the enhanced thickness of the wall of the coupling unit is a second important feature of the present invention. As will be obvious from inspection of the drawings, the wall thickness of the unit proceeds along the neck of the boss toward the flange increasing through the regions B and C and remaining substantially constant in outward progression along the flange from C to the outer end of the flange.

FIG. 4 shows a second embodiment of the invention in the form of a coupling unit 42 having a flange 44 and an axial boss 46. The external surface of the unit at its corner region and adjacent areas may be identical with those of the coupling of FIG. 3. The internal surface of the unit, however, varies substantially from that of the FIG. 3 coupling and instead may be substantially identical with the external surface. As will be obvious, this results in a slight reduction of the thickness of the coupling wall but the unit is nevertheless found to have excellent strength characteristics and is obviously of exceptionally lightweight construction.

A third embodiment of the coupling unit of the present invention is indicated generally at 48 in FIG. 5. The unit has a flange 50 and a boss 52 with an external corner area C with a relatively small radius of curvature similar to that of convention coupling units. The internal surface of the unit at 54, however, is substantially identical with the external surface B, C, and D in FIG. 3 and with the internal and external surfaces in FIG. 4. This entails a substantial radial inward bulge of the inner surface, which will be acceptable in certain applications. Wall thickness is superior in this embodiment to both the FIG. 3 and FIG. 4 embodiments.

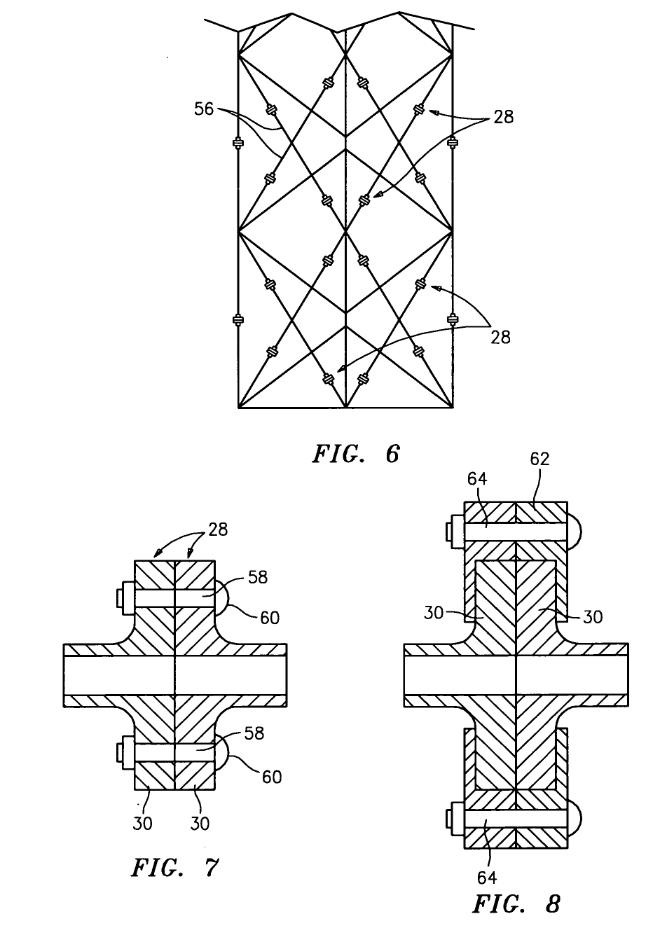

FIG. 6 illustrates a structural use of the improved coupling of the present invention in a wind turbine tower or the like having a plurality of elongated tubular structural members 56, 56 interconnected by coupling units 28, 28 shown in enlarged fragmentary section in FIG. 7. As illustrated in FIG. 7, each of the flanges 30, 30 of mating coupling units 28, 28 is provided with an annular series of axial openings 58, 58 which receive bolts 60, 60 connecting the units together.

In FIG. 8 an alternative means of connection is provided in the form of a clamp member 62 which surrounds the flanges 30, 30 and is in turn interconnected by bolts 64, 64 whereby to clamp and firmly hold the flanges in engagement.

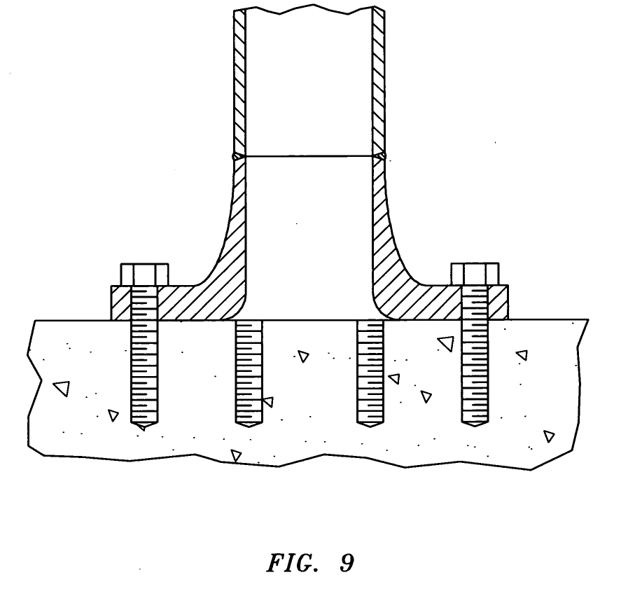

FIG. 9 illustrates the use of a single coupling unit 66 as a mounting support for a large generally vertical elongated base member 68 of a wind turbine tower or the like. The unit 66 may have a configuration substantially identical with the FIG. 3 unit and may be attached to a foundation 70 by a plurality of bolts 72,72 as illustrated.

From the foregoing it will be apparent that design improvements have been made which may initially seem to be minor in nature, but which in the aggregate are nevertheless found to substantially enhance the strength and integrity of the units while simultaneously reducing the weight and the amount of material consumed in manufacture of the improved coupling units.

1. A lightweight high structural integrity flanged coupling unit for use with a similar coupling unit in oppositely oriented interconnected mating relationship for the endwise interconnection of axially aligned similar elongated members; said unit comprising a radially extending generally annular flange having at least a partially generally planar radial surface on one side, a means for rigidly connecting the flange with a mating flange of a similar coupling unit with the planar surfaces of the two flanges engaged in face-to-face relationship, and a boss formed integrally at its inner end portion with the flange to form an external corner surface area therewith on the side thereof opposite its planar surface and projecting axially therefrom for connection with an end portion of a first elongated member, the mating flange having a similar boss for connecting a second elongated member in endwise axially aligned relationship with the first member, and the external surfaces oppositely adjacent to and through the corner area between the flange and boss being substantially arcuate concave throughout deriving from substantially continuously varying radii of curvature between a first imaginary annular line spaced outwardly along and extending around the boss and a second imaginary annular line spaced outwardly along and extending around the flange, opposite ends of the arcuate surface respectively adjacent the first and second imaginary annular lines blending smoothly in transition to a linear surface on the opposite side of the line, the largest radius of curvature being adjacent the first imaginary annular line and the smallest radius of curvature adjacent the second imaginary annular line, and the first imaginary line being substantially farther from the corner between the boss and flange than the second imaginary line.

2. A flanged coupling as set forth in claim 1 wherein the first imaginary line is at least twice as far from the corner of the boss and flange as the second imaginary line.

3. A flanged coupling unit as set forth in claim 1 wherein the first imaginary line is at least three times the distance from the corner of the boss and flange to the free end of the boss.

4. A flanged coupling unit as set forth in claim 1 wherein an infinite number of discrete radii of curvature define the arcuate surface.

5. A flanged coupling unit as set forth in claim 1 wherein at least the elongated members and the boss have circular cross sections.

6. A flanged coupling unit as set forth in claim 1 wherein the flange and the boss have through openings in axial alignment with each other to form an internal annular corner.

7. A flanged coupling unit as set forth in claim 6 wherein the internal corner and oppositely adjacent areas are arcuate convex and substantially identical in contour with the opposite external corner surfaces.

8. A flanged coupling as set forth in claim 7 wherein the internal corner and oppositely adjacent areas have at least two surface defining radii of curvature.

9. A flanged coupling unit as set forth in claim 1 wherein the flange defines a circumaxially spaced series of small axially extending openings for receiving bolts.

10. A flanged coupling unit as set forth in claim 1 and including a clamping device for interconnecting the flange with the mating flange of a similar coupling unit.

11. A flanged coupling unit as set forth in claim 6 wherein the wall thickness of the boss increases in progression from it's free end throughout the length of the boss, throughout the corner area joining the boss and the flange and then remains substantially constant in radial outward progression along the flange.

12. A flanged coupling unit as set forth in claim 1 wherein the arcuate surfaces of the corner between said imaginary annular lines have a smooth curvature approximating the surface of a quadrant of an ellipse.

13. A flanged coupling unit as set forth in claim 6 wherein the inner surface of the corner area between the axial opening in the flange and the adjacent radial area is arcuate, and wherein the external surface of the corner area approximates a portion of the surface of an ellipse.

14. A flanged coupling unit as set forth in claim 6 wherein the internal surface of said corner and adjacent areas approximates a portion of the surface of an ellipse.

15. A flanged coupling unit as set forth in claim 13 wherein the internal surface of said corner region approximates a portion of the surface of an ellipse.

16. A flanged coupling unit as set forth in claim 6 wherein said internal surface of said corner area bulges inwardly relative to the adjacent diameter of the axial bore in the boss.

17. A plurality of flanged coupling units as set forth in claim 1 wherein a like plurality of mating units are provided and assembled together with a plurality of elongated tubular members which are interconnected by the couplings to form a light weight high structural integrity lattice type structure.

18. A plurality of flanged coupling units as set forth in claim 17 wherein the lattice type structure takes the form of a tower for supporting a wind turbine electrical generating system.

19. A flanged coupling unit as set forth in claim 1 wherein the boss and an elongated cylindrical member are butt welded together at the free end of the boss.

20. A lightweight high structural integrity flanged coupling unit for use in endwise connection with an elongated member; said unit comprising a radially extending generally annular flange having at least a partially generally planar radial surface on one side, and a boss formed integrally at its inner end portion with the flange and forming an external corner surface area therewith on the side thereof opposite its planar surface and projecting axially therefrom for connection with an end portion of an elongated member, and the external surfaces oppositely adjacent to and through the corner area between the flange and boss being substantially arcuate concave throughout deriving from substantially continuously varying radii of curvature between a first imaginary annular line spaced outwardly along and extending around the boss and a second imaginary annular line spaced outwardly along and extending around the flange, opposite ends of the arcuate surface respectively adjacent the first and second imaginary annular lines blending smoothly in transition to a linear surface on the opposite side of the line, the largest radius of curvature being adjacent the first imaginary annular line and the smallest radius of curvature adjacent the second imaginary annular line, and the first imaginary line being substantially farther from the corner between the boss and flange than the second imaginary line.

21. A flanged coupling unit as set forth in claim 20 wherein the arcuate surface has a continuously varying and smoothly blending radii of curvature.

22. A flanged coupling unit as set forth in claim 21 wherein an infinite number of discrete radii of curvature define the smoothly blending arcuate surface.

23. A flanged coupling unit as set forth in claim 20 wherein the flange and the boss have through openings in axial alignment with each other to form an internal annular corner.

24. A flanged coupling unit as set forth in claim 23 wherein the internal corner and oppositely adjacent areas are arcuate and convex and substantially identical in contour with the external corner surfaces on an opposite side of the wall of the unit.

25. A flanged coupling unit as set forth in claim 23 wherein the thickness of the wall increases in progression from the free end of the boss throughout the length of the boss, throughout the corner area joining the boss and the flange and then remains substantially constant in radial outward progression along the flange.

26. A flanged coupling unit as set forth in claim 20 wherein the arcuate external surface of the corner between said imaginary annular lines have a surface approximating that of a quadrant of an ellipse.

27. A flanged coupling unit as set forth in claim 26 wherein the internal surface of said corner and adjacent area approximates a portion of the surface of an ellipse.

28. A flanged coupling unit as set forth in claim 20 wherein an annular series of small openings are provided in the flange for mounting the same on a foundation with its boss supporting a generally vertical elongated structural member.

29. A flange coupling unit as set forth in claim 20 wherein at least the elongated members and the boss have cross sections approximating a polygon.
